(19) United States
(12) Patent Application Publication
(10) Pub. No.: US 2009/0019090 A1
(43) Pub. Date: Jan. 15, 2009

(54) METHOD AND DEVICE FOR PRODUCING RECORDINGS ON STORAGE DEVICES

(75) Inventor: Edward John Donnelly, III, South Pasadena, CA (US)

Correspondence Address: CONNOLLY BOVE LODGE & HUTZ LLP, P.O. BOX 2207, WILMINGTON, DE, 19899, US

(73) Assignee: ADERRA INC., Los Angeles, CA (US)

(21) Appl. No.: 12/054,096

(22) Filed: Mar. 24, 2008

Related U.S. Application Data
(60) Provisional application No. 60/946,249, filed on Jul. 11, 2007.

(51) Int. Cl. G06F 17/30

(52) U.S. Cl. 707/201; 707/200; 707/E17.009

(57) ABSTRACT

The invention provides an improved method and system for capturing live events or performances onto portable storage devices as high quality recordings. The portable storage devices may be removably connected to the system or in wireless communication with the system. The signal from the event may include audio and/or visual data, and may be captured as a media file in a memory archive and simultaneously as distribution media files on the portable storage devices. A checksum, cyclic redundancy check, or the like may be implemented to verify that each distribution media is the same as the media file.

### CROSS-REFERENCE TO RELATED APPLICATION

This application claims priority pursuant to 35 U.S.C. §119(e) to U.S. Provisional Application No. 60/946,249, entitled “System and Method for Simultaneous Capture and Duplication of Digital Multimedia Data,” filed Jul. 11, 2007, which application is specifically incorporated herein, in its entirety, by reference.

### BACKGROUND OF THE INVENTION

1. Field of the Invention

The present invention is directed toward creating and distributing recordings of events, and more particularly to system and methods for allowing attendees at a live event to obtain recordings of the event at the event's conclusion.

2. Description of the Related Art

Live events or performances are sometimes recorded while the event is occurring. Sometime after the occurrence of the event, the recording, whether it is audio and/or video content, may be edited and packaged for sale to the public. The recording may be sold or distributed in any number of formats, including but not limited to CD, DVD, SACD, MP3, AAC, FLAC, WAV, streaming audio or video, other types of optical storage media, wireless distribution, internet download or transfer, etc. Low quality and illegal bootleg recordings aside, the time between the live event and the distribution of the high quality or edited recordings of a live event may be considerable, and certainly well after the conclusion of the event.

To assist in making recordings of a live event available to attendees of the event, numerous recording and distribution systems have been proposed or implemented. Such systems may involve malting a master or original recording of the event or performance, and using the original recording to make copies of the original recording soon after the event has concluded. More than one duplication device or the like, such as CD burner or the like, may be used to make copies of the original recording. The copied recordings may be stored on storage devices to be purchased by the event attendees, and/or may be stored on other duplication devices used to make more copied recordings.

However, the time between making the original recording and then subsequently making the copies of the original recording result, as well as the time it takes to make the copies, such as via burning a CD or DVD, creates a lag period. Many attendees of a concert or other live performance immediately exit the venue at the conclusion of the performance. Such attendees are not inclined to wait for someone to create a copy of a master/original recording after the performance has ended. Further, rushing to mass produce copies of an original recording or data file may lead to generation loss, as well as defective, incomplete, or otherwise compromised copies of the original. Accordingly, it would be desirable to provide a system and method that makes it possible to deliver high quality and uncompromised recordings of a performance immediately after the conclusion of the performance.

### SUMMARY OF THE INVENTION

The present invention addresses the shortcomings of the prior art system and methods. In particular, the present invention is directed toward systems and method for producing high quality recordings of a performance that are immediately available at the conclusion of the performance.

In accordance with one aspect of the embodiments described herein, there is provided a device for producing a plurality of recordings of a live event. The device may comprise a recording module in operative communication with a plurality of storage devices. The device may further comprise a receiver module adapted to receive a signal from the event, and a processor module operatively coupled to the first and second receiver modules. The device may further comprise a memory module operatively coupled to the processor module.

The memory module may store executable code for the processor module to: capture the signal as a media file in a memory archive; send the signal to each of the devices for capture as distribution media files on the devices; and compare respective data sizes of the media file and a given distribution media file on a given device. When the respective data sizes are not the same, the processor module may reformat/repartition the given device, and may then send a copy of the media file to the given device.

In accordance with another aspect of the embodiments described herein, there is provided a method for producing a plurality of recordings of an event. The method may comprise: operatively communicating with a plurality of storage devices; receiving a signal from the event; capturing the signal as a compressed file in a memory archive, and simultaneously sending the signal to each of the devices for capture as distribution files on the devices. The method may further comprise comparing respective data sizes of the compressed file and a given distribution file on a given device. When the respective data sizes are not the same, a copy of the compressed file may be sent to the given device.

In accordance with another aspect of the embodiments described herein, there is provided a method for producing a plurality of recordings of a live performance. The method may comprise: receiving a plurality of portable storage devices/units; and when a storage format of a given device of the plurality of devices is not compatible with a predefined format scheme, reformatting the given device according to the predefined format scheme. The method may further comprise, when a file partitioning on the given device is not compatible with a predefined partitioning scheme, repartitioning the given device according to the predefined partitioning scheme.

The method may further comprise: receiving a signal from the performance; capturing the signal as a full resolution file and as a compressed file; and capturing the signal as distribution files on the devices. When the live performance concludes, the respective data sizes of the compressed file and a given distribution file on the given device may be compared. When the respective data sizes are not the same, (a) the compressed file may be copied to the given device, and (b) a redundancy check may be performed to verify all data of the compressed file has been correctly copied onto the given device.

### BRIEF DESCRIPTION OF THE DRAWINGS

FIG. 1 is block diagram of an exemplary embodiment of a system capturing a live event/performance onto a plurality of storage devices.

FIG. 2 illustrates an exemplary embodiment of a recording device.

FIG. 3 is block diagram of an another embodiment of a system capturing a live event onto a plurality of storage devices.

FIG. 4 is block diagram of yet another embodiment of a system capturing a live event onto a plurality of storage devices.

FIG. 5 is a flowchart illustrating the steps of an exemplary method for capturing a live event as original recordings.

FIG. 6 shows the sub-steps of verifying the formatting of the storage devices.

FIG. 7 shows the sub-steps of verifying the partitioning of the storage devices.

FIG. 8 shows the sub-steps of distributing data to the storage devices.

FIG. 9 shows the sub-steps of performing diagnostic tests on the storage devices.

### DETAILED DESCRIPTION

The present invention addresses the need for a system and method for producing a plurality of high quality recordings of a performance immediately available for purchase or distribution immediately after the performance concludes. Such a system may implement protocols for ensuring the viability of the devices onto which the performance is to be recorded. Such a system may implement techniques for reducing generation loss, and for reducing or eliminating defective, incomplete, or otherwise compromised recordings of the performance. Such a system may deliver the performance recordings a variety of portable devices, as well as the attendees' personal mobile devices, in a wired and/or wireless fashion. Such a system or method may be used alone, or in conjunction with other media recording and distribution measures.

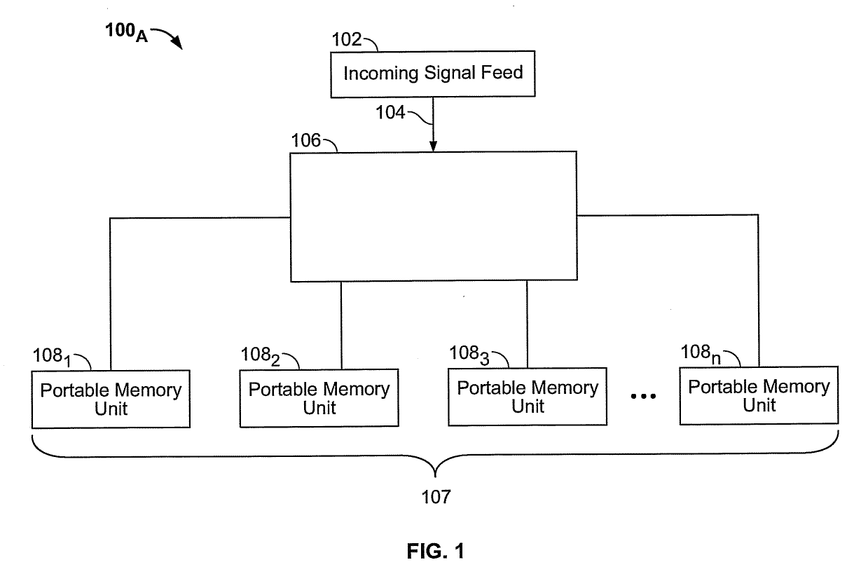

In accordance with one aspect of the embodiments described herein, there is shown in FIG. 1 an exemplary system 100A for producing recordings of a live performance or event 102. The system 100A may comprise a recording device 106 that receives an incoming signal 104 from a live performance or event 102, such as a concert, speech, musical, play, sporting event, etc. The signal 104 may be a signal feed from the event 102, and may be digital or analog. The signal 104 may comprise an audio signal and/or a video signal. The signal 104 may comprise multiple signals, such as the stage sound/video signal(s) and/or the crowd sound/video signal(s).

The signal 104 may comprise supplemental data or information about an event, such as a commentary or a translation of the event, while the event is occurring. The supplemental data may comprise audio, video, graphic, and/or text information about the performance or the performer(s).

The recording device 106 is adapted to receive or communicate with a plurality or a stack of portable storage devices 108₁-108ₙ. The storage devices 108 may be in operative communication with the recording device 106 in any number of ways. For example, one or more of the storage devices/units 108₁-108ₙ may be physically connected to or contained within the recording device 106 in a removable manner. In the alternative, or in addition, one or more of the storage devices 108₁-108ₙ may be communicate with the recording device 106 wirelessly, such as via Bluetooth, Wireless Fidelity (Wi-Fi), cell phone bandwidth, a local wireless mesh network, or via other wireless technologies for data transfer.

Each storage device 108 may comprise any media for storing data, including but not limited to USB storage devices, thumbnail drives, flash memory cards to sticks, compact discs, DVDs, tapes, cassettes, radio frequency identification (RFID) tags, as well as other media now known or later developed. It is noted that the storage media can be placed on or combined with other merchandise sold or distributed at a live event or performance, such as, for example, a USB device on a wristband, keychain, necklace, ID card, nametag, backstage pass, etc.

In the alternative, or in addition, the storage device 108 may comprise mobile devices, including but not limited to cell phones, smart phones, personal digital assistants, pocket PCS, etc. In another alternative, or in addition, the storage device 108 may comprise external computing hardware or accessories, including but not limited to portable game devices, laptops, tablet PCs, etc.

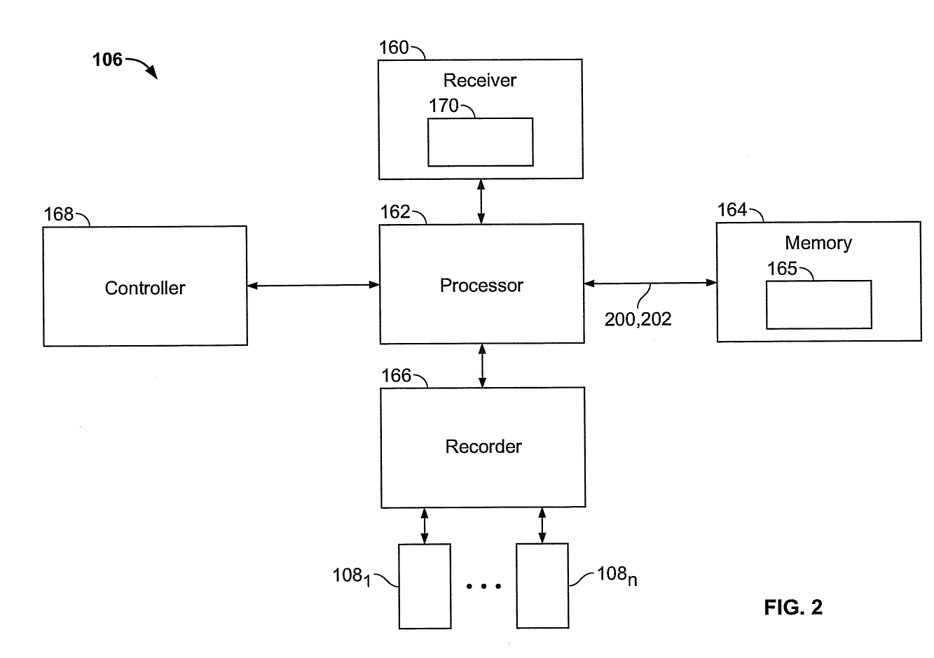

With reference to FIG. 2, there is provided an exemplary embodiment of a recording device 106. The recording device 106 may comprise a receiver module 160, a processor module 162, a memory module 164, a recording/transceiver module 166, and a control module 168. The receiver module 160 may comprise a wired and/or wireless receiver, and may be adapted to receive one or more digital and/or analog signals, such as the signal 104 from the live event 102. The receiver module 160 may comprise one or more filters to extract or filter out certain components (e.g., 60 Hz noise or the like) of the incoming signal 104.

The receiver module 160 may comprise a digital-to-analog converter (DAC) to digitize the signal 104, or components thereof, if the signal 104 comprises analog data or information, which in turn facilitates the mixing/editing and recording of digital data onto the storage devices 108₁-108ₙ. The examples described herein will focus on systems and method for recording digital data onto the devices 108; however, it will be understood, such devices and techniques may also be used to mix/edit and record analog data onto the devices 108₁-108ₙ.

The receiver module 160 may comprise a mixing/editing device 170 or the like to receive and manipulate the audio/video input from one or more signals/channels to achieve desired effects from particular signals. In the alternative, or in addition, the device 170 may be a component of the recording device 106 that is separate from the receiver module 160.

The device 170 may mix, merge, or split the component signals of signal 104 according to preset or predefined settings, or according to instructions, commands, or input settings from the control module 168, such as a sound/video board, control pad, computer keyboard, etc. The settings of the device 170 may be adjusted in response to user input via the control module 168 to the processor module 162. The incoming signal 104 may be converted into two parallel captures, such as a full resolution media file and a compressed media file, as explained in further detail below (see description regarding the processor module 162).

The recording module 166 may comprise ports or connectors for receiving or interfacing with a plurality of storage devices 108₁-108ₙ, such as, for example, USB ports, memory card/stick readers, etc. In the alternative, or in addition, the recording module 166 may comprise media recorders or burners, such as, for example, CD or DVD burners or the like. In another alternative, or in addition, the recording module 166 may comprise one or more transmitters, receivers, and/or transceivers for communicating with the storage devices 108₁-108ₙ, wirelessly or over wires/cables. For example, the recording module 166 may send the mixed/edited version of the signal 104 over the air (i.e., wirelessly) to the customers' mobile phones, which in turn the capture the transmitted data as distribution media files 202 and/or media file copies 201.

The recording module 166 may be adapted to recognize or gather device identifier information each storage device 108 connected (i.e., physically connected or in wireless communication) with the module 166. The module 166 may assign a unique identification (ID) number or identifier to each device 108 that is used throughout the data writing process described in further detail below. The unique identifier or node ID may be valid for the duration of the connection.

The processor module 162 may comprise one or more processors, and may be operatively coupled to the receiver module 160, the memory module 164, and the recording module 166, and the control module 168. The processor module 162 may be adapted to check the formatting, the partitioning, and/or storage capacity of each storage device 108. For example, the processor module 162 may determine whether the is formatted according to a predefined format scheme, such as a formatting based on the user settings of the system. If the format of the device 108 is not compatible or comply with the predefined format scheme, the processor module 162 may make one or more attempts to reformat the device 108 according to the predefined format scheme.

The processor module 162 may also analyze the file partitions on the device 108, and may repartition the device 108 as needed in order to ensure the device 108 is compatible with the recording device 106. If the device 108 is not compatible or comply with a predefined partitioning scheme, the processor module 162 may male one or more attempts to repartition the device 108 according to the predefined partitioning scheme.

The processor module 162 may be adapted to attempt the reformatting and/or repartitioning of the device 108 up to respective predefined numbers of attempts. If the device 108 cannot be properly formatted or partitioned, the processor module 162 may instruct the recording module 166 to eject, remove, disconnect, discontinue communication with, or otherwise deactivate the device. In the alternative, or in addition, the recording module 166 may send a text message or the like to the device 108 indicating the device 108 has failed the diagnostic test and/or is unusable. The text message may notify that customer that the settings of the device 108 must be changed in order to accept the incoming data transfer.

The processor module 162 may be adapted to determine whether the memory or storage capacity of a given storage device 108 meets or exceeds a predefined storage capacity minimum value. If this minimum value is not met, the processor module 162 may deactivate the device 108, or send a text message or the like indicating that the storage capacity of the device 108 has insufficient memory. The processor module 162 may deactivate the device 108 by instructing the recoding module 166 to eject the device 108, and/or by sending a message wirelessly to the device 108 via a wireless transmitter, the message indicating that the storage capacity of the given device 108 does not meet the predefined storage capacity minimum.

If the formatting, partitioning, and/or storage capacity requirements have been met for a given storage device 108, the given device 108 remains in the stack 107 and waits for data. The processor module 162 may capture or record the signal 104 (original or edited/mixed), or components thereof, as a media file 200 in a memory archive 165, which may be a part of a memory module 164.

The captured media file 200 may comprise a compressed media file, and may be embedded in a tape archive (TAR) software format or the like. In the alternative, or in addition, the media file 200 may comprise a full or high resolution media file. In another alternative, or in addition, the recording device 106 may convert the signal 104 into two parallel captures, such as, for example, a full resolution media file and a compressed media file, one or both of which may be saved in the memory module 164.

The processor module 162 may send the signal 104 to one or more of the storage devices 108₁-108ₙ for capture or recording as distribution media files 202 on the storage devices 108₁-108ₙ. It is noted that the media file 200 and the distribution media files 202 are both created or produced from the incoming signal 104, rather than being copied from another master recording produced from the signal 104. In other words, the media file 200 and the distribution media 202 files are original or master recordings, which reduces or eliminates generation loss associated with subsequent generation copies of a master recording.

In the alternative, or in addition, as the media file 200 is being saved to the memory archive 165, the media file 200 may be simultaneously distributed to the storage devices 108₁-108ₙ via wired or wireless connections for capture as distribution media files 202.

The media file 200 and the distribution media files 202 should be the same as long as certain conditions are met. Such conditions may include, for example, making sure that the storage devices 108₁-108ₙ are capable of storing a recording of the event/performance (see above description of diagnostics regarding formatting, partitioning, and memory capacity). Another condition may include ensuring that there were no errors during transfer and recording of data onto each storage device 108, which may involve running redundancy checks or other error detection tests on the files saved onto each storage device 108.

The processor module 162 may perform a first diagnostic test by comparing or checking the respective data sizes of the media file 200 on the memory archive 165 and the distribution media files 202 on the storage devices 108₁-108ₙ. The first diagnostic test may comprise a checksum approach or the like. The exemplary embodiments described herein involve comparing the media file 200 with the distribution media file 202; however, it will be understood that other data file size comparisons may be implemented. For example, in another embodiment, the processor module 162 may compare the respective data sizes of a first distribution media file (of a first one of the media files 200) to the other distribution media files.

When the respective sizes of the media file 200 and a given one of the distribution media files 202 are not the same, the processor module 162 may instruct the recording module 166 to erase the given distribution media file 202, reformat the given storage device 108, and/or repartition the given storage device 108. The processor module 162 may send a media file copy 201, which is a copy of the media file 200 in the memory archive 165, to the recording module 166 for copying onto the device 108. It is noted that the resulting media file copy 201 on the device 108 is not itself an original recording; rather, it is a copy on an original recording, namely, media file 200.

When the respective sizes of the media file 200 and a given one of the distribution media files 202 are the same, the processor module 162 may instruct the recording module 166 to eject the corresponding storage device 108 or otherwise notify/alert the user that the corresponding storage device 108 is ready for sale or distribution to attendees of the live event 102. In the alternative, or in addition, the processor module 162 may instruct the recording module 166 to send a message to a customer, such as via wireless transmission of a message to the customer's mobile phone or other portable electronic device. The transmitted message may indicate that a recording of the live event 102 has been successfully saved onto the customer's mobile phone or the like.

In addition, or in the alternative, the processor module 162 may perform a second diagnostic test on the distribution media files 202₁-202ₙ on the devices 108₁-108ₙ. For example, the second diagnostic test may comprise performing a redundancy check on one or more of the distribution media files 202₁-202ₙ to verify that each distribution media file 202 or media file copy 201 on a portable device 108 is the same as the media file 200 in the memory archive 165. In another example, a first distribution media file (of a first one of the storage devices 108) is compared to each of the other distribution media file of the other storage devices 108.

The redundancy check may involve implementing or performing a cyclic redundancy check (CRC) on the distribution media files 202 and/or the media file copies 201. In the alternative, or in addition, the redundancy check may involve implementing or performing a checksum on the distribution media files 202 and/or the media file copies 201.

When the applied redundancy check or other applicable error detection check does not detect the presence of any errors, the storage device 108 may be ejected, and/or a message indicating the device 108 is ready may be sent (e.g., wirelessly) to the user or customer of system 100A. Otherwise, the device 108 may be reformatted and/or repartitioned, and/or the media file copy 201 may be sent/resent and copied to a given one of the devices 108, after which the redundancy check may be repeated. It is noted that the processor module 162 and/or other components/modules of the system 100A may be adapted to repeat the diagnostic test(s) on the storage devices 108₁-108ₙ as needed.

The memory module 164 may comprise a hard drive and/or flash memory. The memory module 164 may comprise a memory archive 165 for storing the media file 200. The memory module 164 may store compressed and/or high resolution versions of the media file 200 and/or the media file copy 201. The memory module 164 may be operatively connected to the processor module 162, and may comprise executable code or instructions that are performed by the processor module 162.

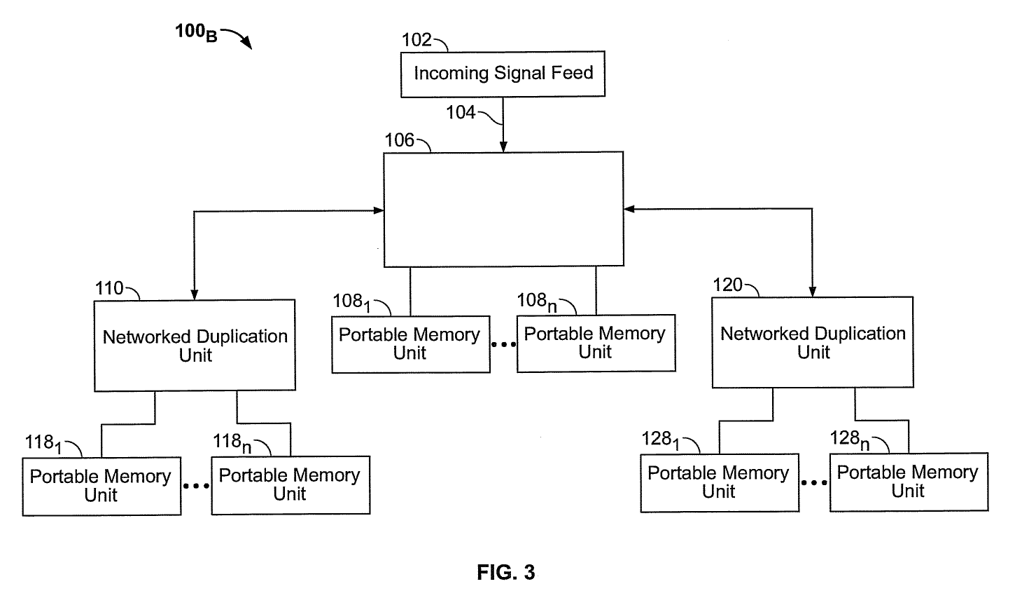

It is further noted that the system for producing recordings of a live performance or event 102, such as system 100A shown in FIG. 1, may be modified to increase the number of storage devices 108₁-108ₙ onto which the event 102 may be recorded. For example, with reference to the embodiment of FIG. 3 the system 100B may comprise one or more duplication units or stations, such as duplication units 110 and 120, that may be networked or in communication (wired or wireless) with the recording device 106. The networked duplication units 110, 120 may comprise module/components that are the same or similar to those of the recording device 106, including but not limited to a receiver module, a processor module, a memory module, a recording module, and a control module. The duplication units 110, 120 may receive the signal 104 from the recording device 106. In the alternative, or in addition, the duplication units 110, 120 may receive the signal 104 directly from the live event 102. The duplication units 110 and 120 may capture the signal 104 as recordings on storage devices 118 and 128, respectively. The rest of the system 100B shown in FIG. 3 is similar to the system 100A shown in FIG. 1.

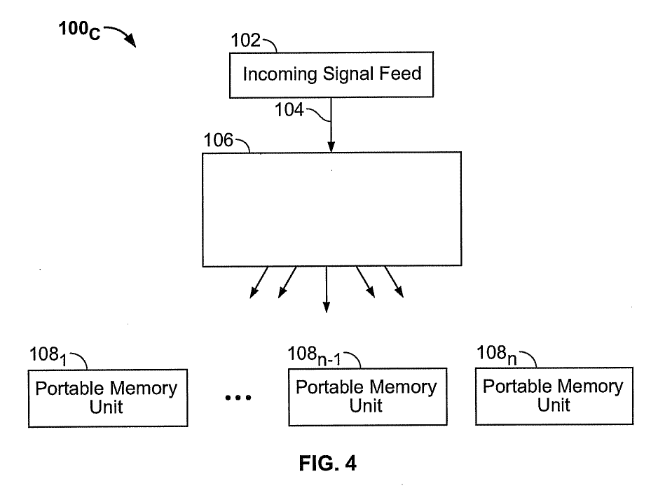

As explained above, in one embodiment, the storage devices 108₁-108ₙ may comprise mobile phones or other devices that are in wireless communication with the recording device 106 and/or supplemental duplication units. With reference to the embodiment of FIG. 4, there is provided a system 100C for capturing the incoming signal 104 as recordings onto devices 108₁-108ₙ that are not physically connected to the system 100C or its components. A recording module or the like of the recording device 106 may communicate wirelessly with one or more of the devices 108₁-108ₙ, and may transfer data to the devices 108₁-108ₙ via any known or subsequently developed wireless data transfer protocol. The rest of the system 100C shown in FIG. 4 is similar to the system 100A shown in FIG. 1.

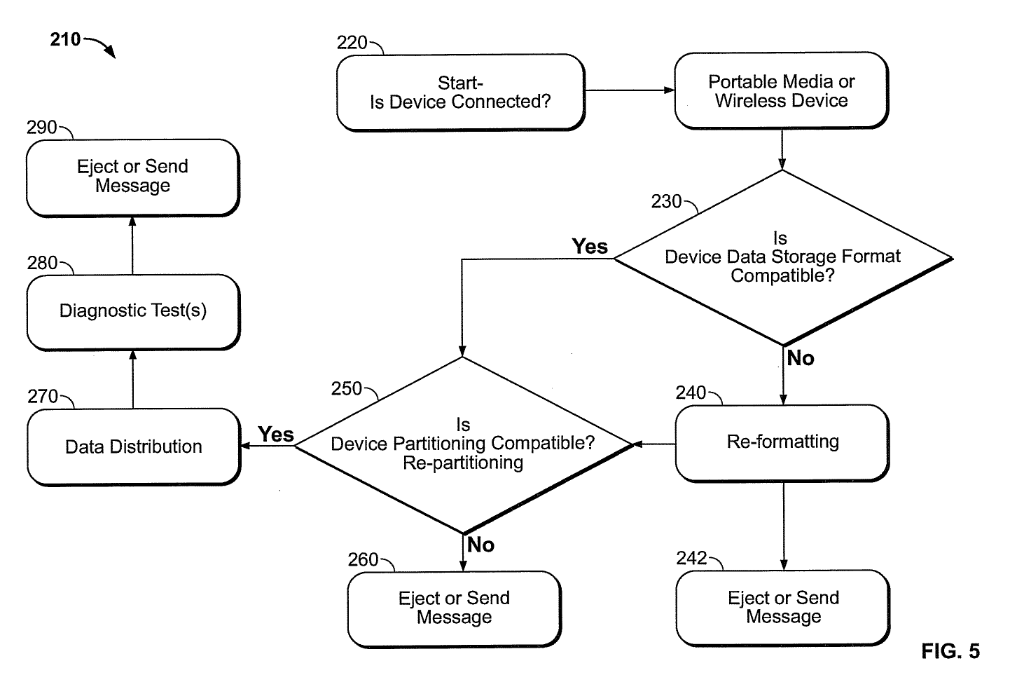

In accordance with another aspect of the embodiments described herein, there is provided a method for producing a plurality of recordings of a live event. With reference to FIG. 5, in one approach, the method 210 may involve receiving or operatively connecting with the a plurality/stack of storage devices, and/or determining that each storage device is properly operatively connected (step 220). Next, the method, at step 230, may involve determining whether the format of the a storage device is compatible with a defined or selected format scheme. If not, one or more attempts (up to a predefined maximum number of attempts) may be made to reformat the storage device to be compatible with the defined format scheme (step 240). If the storage device cannot be properly formatted, the storage device may be ejected or disconnected (step 242). In the alternative, or in addition, a message (e.g., a text message or email) may be sent wirelessly to the storage device. If the storage device is properly formatted, the method proceeds to step 250.

At step 250, the method may involve determining whether the storage device is partitioned in a compatible way. If not, one or more attempts (up to a predefined maximum number of attempts) may be made to repartition the storage device to be compatible with a defined or selected partitioning scheme. If the storage device cannot be properly formatted, the storage device may be ejected or disconnected (step 260). In the alternative, or in addition, a message may be sent wirelessly to the storage device. If the storage device is properly formatted, the method proceeds to data distribution step 270.

At step 270, the method involves distributing the data associated with the incoming signal feed from the live event/performance to the storage devices. The incoming signal may be captured as a media file in a memory archive, and also as distribution media files on the storage devices. Next, the method proceeds to step 280, where one or more diagnostic tests may be performed to determine whether there were any errors during the transfer and recording of data onto the storage devices. Step 280 may coincide with the point in time when the recording of the entire event stops, and/or with selected points during the event (e.g., in between songs during a musical concert).

If an error is detected, a copy of the media file (or a copy of a selected one of the distribution media files) may be sent to the storage device for recopying. In the alternative, or in addition, the storage device may be reformatted and/or repartitioned. When the distribution media file or the media file copy has been saved onto the storage device, the storage device may be ejected or disconnected (step 290). In the alternative, or in addition, a message may be sent wirelessly to the storage device, wherein the message may indicate that the event/performance has been saved on the storage device.

In one embodiment, the storage devices with uncorrectable formatting, partitioning, memory capacity, and/or data transfer problems may be ejected from the recording device. In another embodiment, LEDs, color coded schemes, or other visible indicators may be used to identify and separate those storage devices ready to be sold to the event attendees from those storage devices that remain uncorrectable (i.e., those storage devices that fail to meet one or more pre/post data transfer diagnostic tests). For example, LED may be placed on or next to the storage devices, wherein a first LED color code may indicate that the storage device has successfully stored a recording of the event, while a second LED color code may indicate that the storage device has failed one or more diagnostic tests. In yet another embodiment, a graphical user interface or the like is used to map and provide status information regarding the networked connections with the storage devices and/or duplication units. Such a graphical user interface may be presented on a display unit/module that may be operatively coupled to a processor module of the recording device or system.

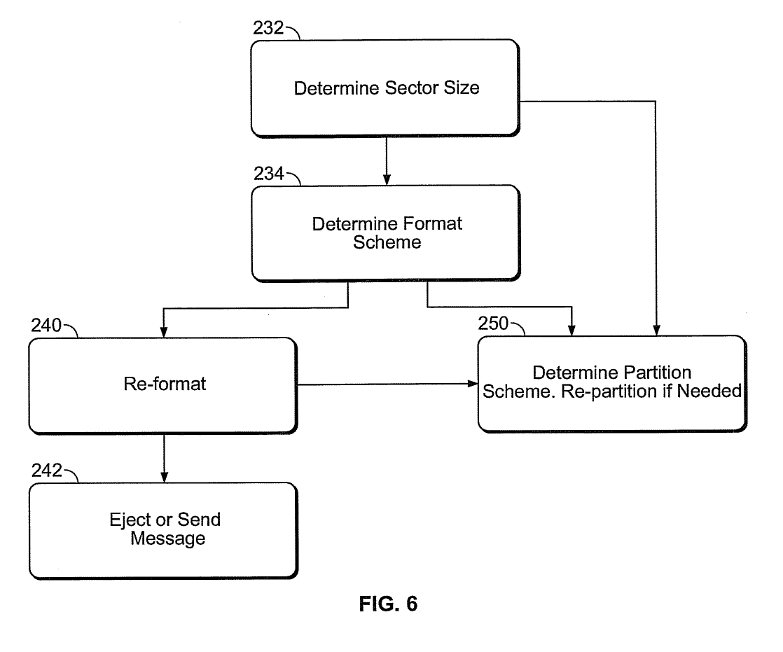

With reference to FIG. 6, in one approach, step 230 may involve determining the sector size (sub-step 232). If the sector size is larger than 512, the method may proceed to step 250 (partitioning). If the sector size is 512 or smaller, the format scheme of the storage device may be determined (sub-step 234). If the format scheme of the storage device matches the user settings or a selected/defined formatting scheme, the method may proceed to step 250. Otherwise, one or more attempts may be made to reformat the storage device according to the user settings (step 240). When the storage device is successfully reformatted, the method may proceed to step 250; otherwise, the storage device may be ejected/removed or sent a message indicating the storage device cannot be properly formatted (step 242).

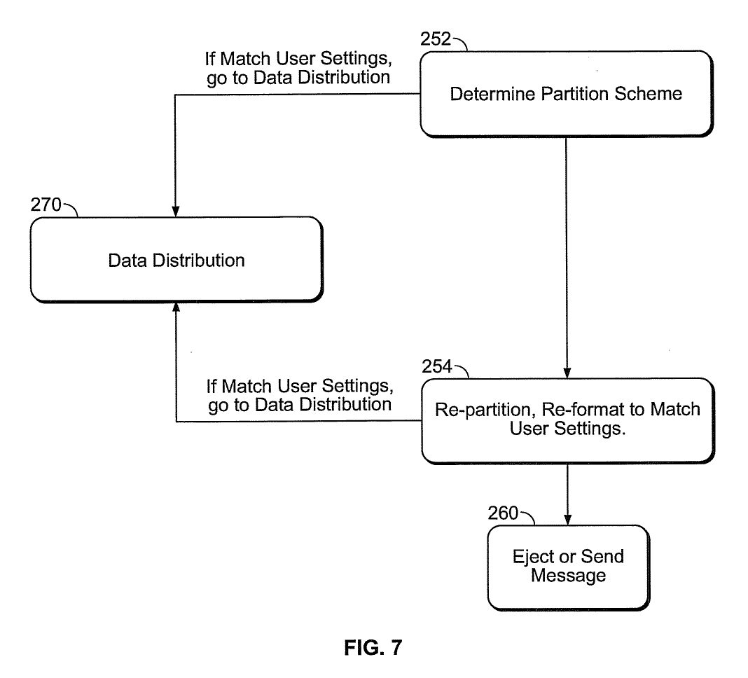

With reference to FIG. 7, in one approach, step 250 may involve determining the partition scheme of the storage device (sub-step 252). If the partition scheme matches the user settings or a selected/defined partitioning scheme, the method may proceed to step 270. Otherwise, if the sector size is larger than 512, one or more attempts may be made to repartition the storage device according to the user settings (sub-step 254). When the storage device is successfully repartitioned, the method may proceed to step 270; otherwise, the storage device may be ejected/removed or sent a message indicating the storage device cannot be properly partitioned (step 260).

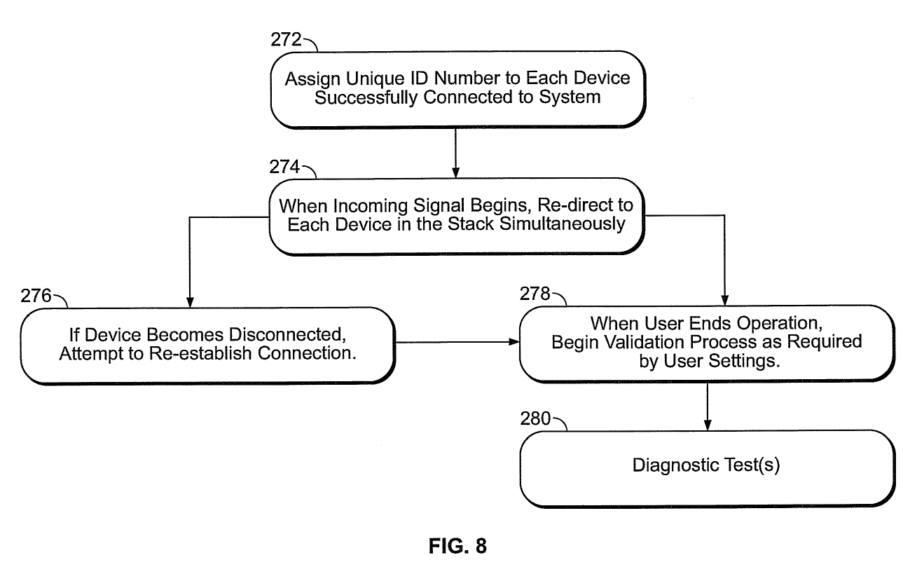

With reference to FIG. 8, in one approach, step 270 may involve assigning a unique ID number to each storage device successfully connected to the recording device or system (sub-step 272). Next, at sub-step 274, when the incoming signal (i.e., the signal from the performance/event) begins, the incoming signal is captured as a media file and/or simultaneously redirected to each storage device in the stack. As noted above, the incoming signal may comprise audio and/or visual signals from the performance, as well as supplemental data, such as audio, video, graphic, and/or text information about the performance or the performer(s). In the alternative, or in addition, the supplemental data may comprise links to data files on the storage devices and/or links to external web sites, sponsored advertisements, etc.

At sub-step 276, if the storage device becomes disconnected, one or more attempts (up to a predefined maximum number of attempts) may be made to re-establish connection. If the predefined maximum number of attempts are not enough to re-establish connection, the storage device may be ejected/removed or sent a message. The unique ID number for the storage device may become available for another storage device. When the user ends operation, such as by hitting a stop button or the like at the conclusion of the performance/event (at sub-step 278), the validation or diagnostic steps may begin (see step 280).

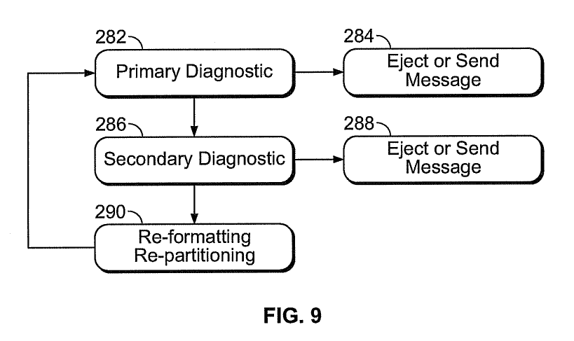

With reference to FIG. 9, in one approach, step 280 may involve performing a primary diagnostic test, such as comparing the respective data sizes of the media file in the memory archive and the distribution media files on the storage devices, such as via a checksum approach or the like (sub-step 282). The exemplary embodiments described herein involve comparing the media file 200 with the distribution media file 202; however, it will be understood that other data file size comparisons may be implemented. For example, sub-step 282 may comprise comparing the respective data sizes of a first distribution media file (of a first one of the media files) to the other distribution media files via a checksum approach or the like.

If the respective sizes of the compared files are the same, the storage device is ejected or sent a message indicating that the event/performance has successfully been recorded onto the storage device (sub-step 284). In the alternative, or in addition, a secondary diagnostic test may be performed, such as by performing a redundancy check (e.g., a checksum or CRC).

If the respective sizes of the compared files are not the same, one or more attempts (up to a predefined maximum number) may be made to send a media file copy to the given storage device (sub-step 282). In the alternative, or in addition, one or more attempts may be made to send a copy of a first distribution file (on a first one of the storage devices) to the given storage device.

Next, at sub-step 286, a secondary diagnostic test may be performed. If the requirements of the secondary diagnostic test are satisfied, the storage device may be ejected or sent a message (sub-step 288). If the requirements of the secondary diagnostic test are not satisfied, the method may proceed to sub-step 290, where the storage device may be reformatted and/or repartitioned, and then optionally proceed back to sub-step 282.

While the present invention has been illustrated and described with particularity in terms of preferred embodiments, it should be understood that no limitation of the scope of the invention is intended thereby. Features of any of the foregoing methods and devices may be substituted or added into the others, as will be apparent to those of skill in the art. It should also be understood that variations of the particular embodiments described herein incorporating the principles of the present invention will occur to those of ordinary skill in the art and yet be within the scope of the invention.

What is claimed is:

1. A device for producing a plurality of recordings of a live event, comprising:
a recording module in operative communication with a plurality of storage devices;
a receiver module adapted to receive a signal from the event;
a processor module operatively coupled to the first and second receiver modules; and
a memory module operatively coupled to the processor module, the memory module comprising executable code for the processor module to:
capture the signal as a media file in a memory archive;
send the signal to each of the devices for capture as distribution media files on the devices;
compare respective data sizes of the media file and a given distribution media file on a given device; and
when the respective data sizes are not the same, send a copy of the media file to the given device.

2. The device of claim 1, wherein the recording module is removably connected with at least one of the devices.

3. The device of claim 1, wherein the recording module communicates wirelessly with at least one of the devices.

4. The device of claim 1, wherein the receiver module is adapted to digitize the signal when the signal comprises an analog signal.

5. The device of claim 1, wherein the received signal comprises at least one of an audio signal and a video signal.

6. The device of claim 1, wherein the memory module further comprises executable code for the processor module to, when a storage format of the given device of the plurality of devices is not compatible with a predefined format scheme, reformat the given device according to the predefined format scheme.

7. The device of claim 1, wherein the memory module further comprises executable code for the processor module to, when a file partitioning on the given device is not compatible with a predefined partitioning scheme, repartition the given device according to the predefined partitioning scheme.

8. The device of claim 1, wherein the memory module further comprises executable code for the processor module to, perform a redundancy check to verify all data of the media file has been correctly copied onto the given device.

9. The device of claim 8, wherein the processor module performs a redundancy check by performing a checksum on the copy of the media file on the given device.

10. The device of claim 8, wherein the processor module performs a redundancy check by performing a cyclic redundancy check (CRC) on the copy of the media file on the given device.

11. The device of claim 1, wherein the media file is in a compressed format.

12. The device of claim 11, wherein the processor module further captures the signal as a full resolution file.

13. The device of claim 1, wherein the memory module further comprises executable code for the processor module to:
determine whether a storage capacity of the given device meets a predefined storage capacity minimum; and
deactivate the given device when the predefined storage capacity minimum is not met.

14. A method for producing a plurality of recordings of an event, comprising the steps of:
operatively communicating with a plurality of storage devices;
receiving a signal from the event;
capturing the signal as a compressed file in a memory archive, and simultaneously sending the signal to each of the devices for capture as distribution files on the devices;
comparing respective data sizes of the compressed file and a given distribution file on a given device; and
when the respective data sizes are not the same, sending a copy of the compressed file to the given device.

15. The method of claim 14, wherein operatively communicating with the devices comprises communicating wirelessly with at least one of the devices.

16. The method of claim 14, wherein receiving the signal comprises receiving at least one of an audio signal and a video signal.

17. The method of claim 14, further comprising, when a storage format of the given device of the plurality of devices is not compatible with a predefined format scheme, reformatting the given device according to the predefined format scheme.

18. The method of claim 14, further comprising, when a file partitioning on the given device is not compatible with a predefined partitioning scheme, repartitioning the given device according to the predefined partitioning scheme.

19. The method of claim 14, further comprising performing a redundancy check to verify all data of the compressed file has been correctly copied onto the given device.

20. A method for producing a plurality of recordings of a live performance, comprising the steps of:
receiving a plurality of portable storage devices;
when a storage format of a given device of the plurality of devices is not compatible with a predefined format scheme, reformatting the given device according to the predefined format scheme;
when a file partitioning on the given device is not compatible with a predefined partitioning scheme, repartitioning the given device according to the predefined partitioning scheme;
receiving a signal from the performance;
capturing the signal as a full resolution media file and as a compressed media file;
capturing the signal as distribution media files on the devices;
when the live performance concludes, comparing respective data sizes of the compressed media file and a given distribution media file on the given device; and
when the respective data sizes are not the same, (a) copying the compressed media file to the given device, and (b) performing a redundancy check to verify all data of the compressed media file has been correctly copied onto the given device.
